(19) United States
(12) Patent Application Publication
(10) Pub. No.: US 2025/0246650 A1
(43) Pub. Date: Jul. 31, 2025

(54) SYSTEM AND METHOD FOR MAXIMIZING THE OPERATING TIME OF FUEL CELL STACKS

(71) Applicant: Robert Bosch GmbH, Stuttgart (DE)

(72) Inventor: Mark Hellmann, Korntal (DE)

(21) Appl. No.: 18/703,449

(22) PCT Filed: Oct. 24, 2022
(86) PCT No.: PCT/EP2022/079598

§ 371 Date: Apr. 22, 2024

(30) Foreign Application Priority Data
Oct. 26, 2021 (DE) 10 2021 212 052.0

(51) Int. Cl. H01M 8/04302; B60R 16/033; H01M 8/04537; H01M 8/04664

(52) U.S. Cl. CPC H01M 8/04302; B60R 16/033; H01M 8/04559; H01M 8/04649; H01M 8/04679; H01M 2250/20

(57) ABSTRACT

The presented invention relates to a fuel cell system (100) having a plurality of fuel cell stacks (101, 103, 105) and a control device (107), to a method for operating a fuel cell system (100), and to a vehicle having a fuel cell system (100).

### BACKGROUND

The present invention relates to a fuel cell system, a method, and a vehicle.

Fuel cell systems comprising multiple fuel cell stacks are often used in buses, as well as medium and heavy trucks. In real operation, often only small and medium power is required, so one or even several fuel cell stacks can be shut down, and operation is performed using only a selection of fuel cell stacks of an overall fuel cell system.

To achieve a predefined service life of, e.g., 20,000 hours it is necessary to control the respective fuel cell stacks of a fuel cell system using a correspondingly optimized operating strategy. In particular, it should be avoided that a first fuel cell stack is always active and all further fuel cell stacks are only connected as needed, since this would place a heavy load on the first fuel cell stack compared to the other fuel cell stacks and possibly lead to a premature failure of the first fuel cell stack and a corresponding minimum service life of the fuel cell system.

### SUMMARY

Presented in the context of the invention presented are a fuel cell system, a method, and a vehicle. Further features and details of the invention will emerge from the respective dependent claims, the description, and the drawings. In this context, features and details described in connection with the fuel cell system according to the invention clearly also apply in connection with the method according to the invention, and respectively vice versa, so mutual reference to the individual aspects of the invention is or can always be made with respect to the disclosure.

The invention presented is in particular used to enable operation of a fuel cell system comprising a plurality of fuel cell stacks such that it can be operated at full load, i.e., using energy from all fuel cell stacks up to the end of its service life. Accordingly, the invention presented is used to minimize a time between wear-related failures of different fuel cell stacks of a fuel cell system and to avoid operation of the fuel cell system using a reduced number of fuel cell stacks.

Therefore, presented according to a first aspect of the invention is a fuel cell. The fuel cell system comprises a plurality of fuel cell stacks and a control device, the control device being configured to assign each fuel cell stack of the plurality of fuel cell stacks a state metric that quantifies an aging state of the fuel cell stack in order to activate respective fuel cell stacks of the plurality of fuel cell stacks depending on the state metric such that a difference between the state metric of the respective fuel cell stacks is minimized.

In the context of the invention presented, a state metric is understood to mean a value or a mathematical quantity that quantifies a physical state of a fuel cell stack. For this purpose, the state metric is determined based in particular on measured values of physical properties of a fuel cell stack. For example, a state metric can be a value on a scale, e.g., a school grading scale or a percentage scale.

The invention presented is based on the principle that each fuel cell stack of a plurality of fuel cell stacks of a fuel cell system is assigned a state metric. Based on the respective state metrics, the respective fuel cell stacks are selected for activation such that a difference between the state metrics of the respective fuel cell stacks is minimized. In other words, a deviation of the state metrics of the different fuel cell stacks is minimized by selective activation of the different fuel cell stacks. Accordingly, uneven use and the resulting uneven wear as well as the resulting uneven deactivation of individual fuel cell stacks are avoided and a full performance of the fuel cell system is maintained over its entire life. It can then be determined which fuel cell stack is in the best condition or is least worn. These fuel cell stacks having the better states can then be activated more frequently to obtain an adjustment in wear to the fuel cell stacks, which are already in a worse state. So, starting with the best fuel cell stack, these can be activated such that matching to the worse fuel cell stacks is achieved.

A predefined assignment scheme can, e.g., be used to assign a state metric to a respective fuel cell stack, which assigns a specific state metric to the respective measured values determined by means of a sensor.

It can be provided that the control device is configured for a connection operation, in which an inactive fuel cell stack of the plurality of fuel cell stacks is to be activated due to a power requirement to select that fuel cell stack from the plurality of fuel cell stacks which, of all non-activated fuel cell stacks of the plurality of fuel cell stacks, has the state metric which comes closest to a reference state metric which was determined in particular in a delivery state of the fuel cell system.

A condition is particularly suitable as a selection criterion for selecting a fuel cell stack to be activated in response to a load requirement, according to which the fuel cell stack is selected that has the state metric closest to a reference state metric, which was determined in particular in a delivery state of the fuel cell system. In other words, the fuel cell stack whose state corresponds most closely to a delivery state is always activated so that the fuel cell stacks with higher wear are protected.

In particular, the use of the state metric provided in accordance with the invention enables maintenance of individual fuel cell stacks without the need for maintenance of the other fuel cell stacks because one state of the maintained fuel cell system approaches the state of the further fuel cell stack via the activation strategy according to the invention by the fuel cell stack undergoing maintenance being activated to a greater extent than other fuel cell stacks.

It can further be provided that the control device is configured to determine a voltage applied to a respective fuel cell stack at a predetermined reference operating point and assign a state metric to the determined voltage using a predetermined assignment scheme.

Given that a voltage applied to a fuel cell stack changes relative to a state of the fuel cell stack, i.e., due to wear, a voltage value measured by a voltage sensor is particularly suitable as a basis for assigning a state metric.

In order to compare a current state of a fuel cell stack with a reference state, e.g., a delivery state, a measurement of the voltage at a predetermined reference operating point, e.g., during operation at a predetermined load, can be provided.

It can further be provided that the control device is configured to determine a voltage hysteresis of a voltage applied to a particular fuel cell stack at a predetermined reference operating point change and assign a state metric to the voltage hysteresis using a predetermined assignment scheme.

Given that a hysteresis, i.e., a response behavior of a fuel cell stack to a changed load requirement, changes dependently on wear, a hysteresis of the voltage of a fuel cell stack, i.e., a change in the voltage between two operating points, is in particular suitable for the assessment of a state of the fuel cell stack, and correspondingly as the basis for assigning the state metric.

It can further be provided that the control device is configured to apply a predetermined electrical current to a respective fuel cell stack in order to determine an electrical resistance of the fuel cell stack and to assign a state metric to the electrical resistance of the fuel cell stack using a predetermined assignment scheme.

Given that an electrical resistance of a fuel cell stack changes relative to a state of the fuel cell stack, i.e., due to wear, an electrical resistance value of the fuel cell stack determined by means of, e.g., voltage values measured by a voltage sensor is particularly suitable as a basis for assigning a state metric.

In order to compare a current state of a fuel cell stack with a reference state, e.g., a delivery state, an electrical resistance can be used at a predetermined reference operating point, e.g., when operating at a predetermined load.

An impedance measurement can, e.g., be performed in order to determine the electrical resistance.

It can further be provided that the control device is configured to determine a resistance hysteresis of an electrical resistance of a respective fuel cell stack at a predetermined reference operating point change and assign a state metric to the resistance hysteresis using a predetermined assignment scheme.

Given that a hysteresis, i.e., a response behavior of a fuel cell stack to a changed load requirement, changes, depending on the closure, a hysteresis of the electrical resistance of a fuel cell stack, i.e., a change in the electrical resistance between two operating points, is in particular suitable for the assessment of a state of the fuel cell stack, and correspondingly as a basis for assigning the state metric.

It can further be provided that the control device is configured to determine a state of the fuel cell stack on at least one catalyst layer and at least one membrane and/or a mass transport path of respective fuel cells of the fuel cell stack, and assign a catalyst state metric to the catalyst layer and a membrane state metric to the membrane and/or a mass transport path metric to the mass transport path, whereby the control device is further configured to, in the event that a load requirement is present in a partial load range that is below a predefined threshold value, select that fuel cell stack for activation in response to the load requirement whose catalyst state metric comes closest to a reference catalyst state metric, which has been determined in particular in a delivery state of the fuel cell system, or, in the event that a load requirement that is above the predefined threshold value, to select the fuel cell stack for activation in response to the load requirement, whose membrane state metric comes closest to a reference membrane state metric, which has been determined in particular in a state of delivery of the fuel cell system, or, in the event that a load requirement is present in a partial load range which is above the predefined threshold value, to select that fuel cell stack for activation in response to the load requirement, whose mass transport path state metric comes closest to a reference mass transport path state metric, which was determined in particular in a delivery state of the fuel cell system.

A load-dependent selection of a fuel cell stack to be activated enables internal states of different fuel cell stacks to be matched by, e.g., a fuel cell stack being activated in response to a load requirement that corresponds to a lower partial load range, and selecting the fuel cell stack that has comparatively low degradation of the catalyst layers for activation, since the degradation of the catalyst layers occurs in particular in partial load operation.

Furthermore, matching internal states of different fuel cell stacks can be achieved by selecting a fuel cell stack for activation at a medium or high load requirement having a comparatively low degradation of the membrane and/or mass transport paths.

It can further be provided that the control device is configured to predict the load requirement for a respective fuel cell stack for a predefined period of time based on operating parameters of the fuel cell system.

Based on operating parameters, e.g. a state of a battery of the fuel cell system, a route to be traveled, corresponding traffic information, or the like, it is possible to draw conclusions about an expected power requirement of a fuel cell stack to be activated such that the selection of the fuel cell stack can be optimized for future expected events, e.g., a fuel cell stack whose catalyst state metric is particularly close to a reference catalyst state metric is selected for activation for a predicted partial load range.

It can further be provided that the control device is configured to activate the respective fuel cell stacks of the plurality of fuel cell stacks in a closed control loop depending on the state metric.

A “closed loop” process can achieve a reliable approximation of matching of the respective fuel cell stacks of a fuel cell system.

It can further be provided that the control device is configured to, given a decreasing power requirement, select for deactivation the fuel cell stack whose state metric deviates the most from its reference state metric, which has been determined in particular in a delivery state of the fuel cell system.

By preferentially deactivating fuel cell stacks whose state metric deviates the most from their reference state metric, fuel cell stacks with particularly high wear are protected. Correspondingly, the wear conditions of all fuel cell stacks are forced to be matched.

According to a second aspect, the presented invention relates to a method for operating a fuel cell system comprising a plurality of fuel cell stacks, in particular for operating a fuel cell system according to the first aspect of the invention. The method comprises assigning a state metric to each fuel cell stack of the plurality of fuel cell stacks, in which case the state metric quantifies an aging state of the fuel cell stack, and activating respective fuel cell stacks of the plurality of fuel cell stacks as depending on the state metric such that a deviation between the state metrics of the respective fuel cell stacks is minimized.

The method presented is particularly useful for operating the fuel cell system presented.

In particular, the method presented comprises an assignment step in which the state metric is assigned according to a predefined assignment scheme to a determined physical state parameter, e.g., a measured value of a voltage or a determined value of an electrical resistance.

In a third aspect, the invention presented relates to a vehicle comprising a possible configuration of the fuel cell system presented.

The method according to the second aspect of the invention as well as the vehicle according to the third aspect of the invention have the same advantages as those described in detail regarding the fuel cell system according to the first aspect of the invention.

### BRIEF DESCRIPTION OF THE DRAWINGS

Further advantages, features, and details of the invention will emerge from the following description, in which exemplary embodiments of the invention are described in detail with reference to the drawings. In this context, the features specified in the claims and in the description can each be essential to the invention, individually or in any combination.

Shown are:

FIG. 1 a schematic representation of a possible embodiment of the fuel cell system presented,

FIG. 2 a schematic representation of a possible configuration of the method presented,

FIG. 3 a schematic representation of a further possible configuration of the vehicle presented,

### DETAILED DESCRIPTION

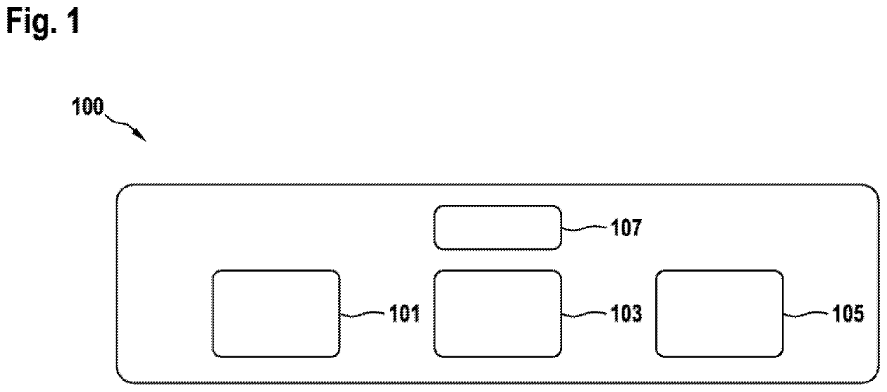

FIG. 1 shows a fuel cell system 100. The fuel cell system 100 comprises a first fuel cell stack 101, a second fuel cell stack 103, a third fuel cell stack 105, and a control device 107.

In the present case, the first fuel cell stack 101 shows the greatest wear, the second fuel cell stack 103 shows the second largest wear, and the third fuel cell stack 105 shows the least wear. Accordingly, the third fuel cell stack 105 should be selected for activation in response to a load requirement in order to match a wear of the fuel cell stacks 101, 103 and 105.

To automatically select a fuel cell stack to be activated in response to a load requirement, the control device 107 assigns a state metric to each of the fuel cell stacks 101, 103, and 105. For this purpose, the control device use a sensor to measure a physical property of each fuel cell stack 101, 103 and 105, e.g., a voltage at a reference operating point, and assign a corresponding state metric according to a predefined assignment scheme to the respective measured values.

Given that the third fuel cell stack 105 shows the lowest wear In the present case, its state metric is particularly close to a predefined reference state metric or a reference state metric determined for a delivery state (meaning, e.g., particularly high) and has a value of 9 on a scale of 1 to 10 in the present case, whereas the second fuel cell stack 103 is assigned a state metric 7, and the first fuel cell stack 6 is assigned a state metric in the present case.

In order to minimize a deviation of the state metrics of the fuel cell stack 101, 103 and 105, the fuel cell stack whose state metric comes closest to the reference state metric, which can, e.g., be determined individually for each fuel cell stack is selected for activation by the control device 107. In the present case, the reference state metric for each of the fuel cell stacks 101, 103 and 105 has the value 10, so that the state metric 9 of the third fuel cell stack 105 comes closest to the reference state metric. Accordingly, the control device 107 selects the third fuel cell stack 105 for activation.

Activation of the third fuel cell stack 105 increases its wear, so that its state metric decreases until it falls below the value 7 and the second fuel cell stack 103 is selected for activation accordingly.

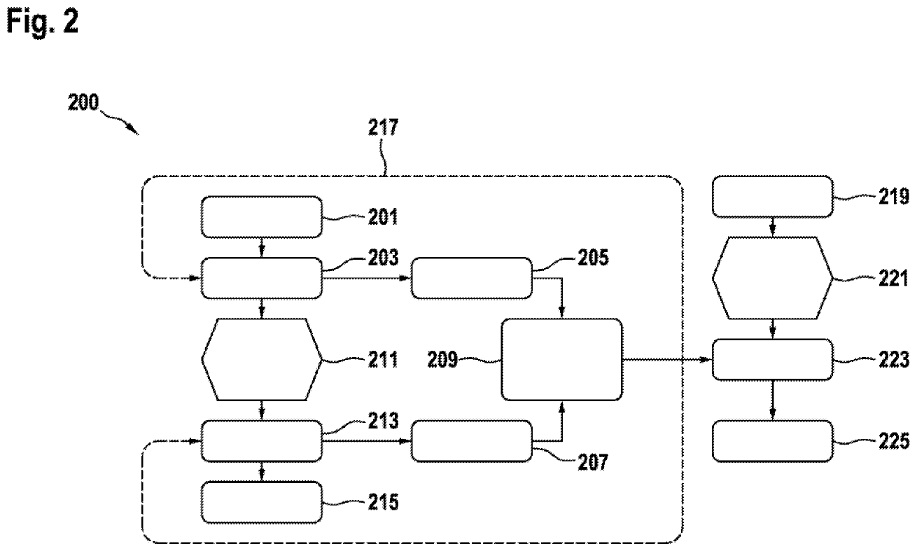

A method 200 is shown in FIG. 2. The method 200 comprises an initialization step 201 in which an initial power requirement is, e.g., provided by a driver of a vehicle.

In a selection step 203, that fuel cell stack is selected from a plurality of fuel cell stacks whose state metric corresponds to a minimum amount of wear. As indicated by line 217, state information that is still stored from a previous operation is used for this purpose.

Once a corresponding fuel cell system is started, a state metric is determined for a first fuel cell stack in a determination step 205 and a state metric is determined for a further fuel cell stack in a further determination step 207.

The state metrics determined in determination steps 205 and 207 are stored in memory in a storage step 209.

If a power requirement is then increased in a requirement step 211 such that an additional fuel cell stack needs to be activated, the fuel cell stack that has the status metric that corresponds to the lowest wear among the non-activated fuel cell stacks is activated in an activation step 213.

In a repetition step 215, the activation step 213 is repeated until the power requirement is met or all fuel cell stacks are activated.

If a decreasing power requirement then occurs in a request step 219, a check step 221 checks whether the power requirement falls below a predefined threshold, so that a fuel cell stack is intended to be shut down. If this is the case, the fuel cell stack is switched off in a shutdown step 223 which, among the activated fuel cell stacks, has the state metric that corresponds to the highest wear.

In a repetition step 225, the shutdown step 223 is repeated until the power requirement is met or all fuel cell stacks are turned off.

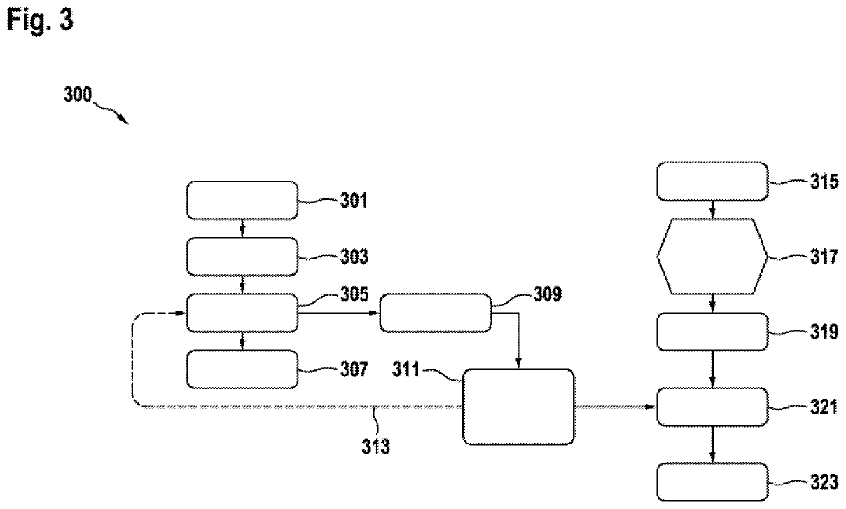

FIG. 3 shows a method 300. The method 300 enables matching of the wear states of different fuel cell stacks and different components within respective fuel cell stacks of a fuel cell system.

The method 300 comprises an initialization step 301 in which an initial power requirement is, e.g., provided by a driver of a vehicle.

In a predicting step 303, a predict of a load requirement to be expected in the future is created, e.g., based on information on a route to be traveled, and a lower partial load range or an upper partial load range is categorized.

In an operation step 305, the fuel cell system is operated in the predicted load range using those fuel cell stacks assigned to the predicted load range. For example, the fuel cell stacks in a partial load range are selected for activation if they show particularly little wear on those catalyst layers and those fuel cell stacks are selected for activation in a high load range if they show particularly little wear on their membranes and/or mass transport paths.

In a repeat step 307, the fuel cell stacks are selected accordingly until all of the fuel cell stacks are activated or the power requirement is met.

Once the fuel cell system has started, a determination step 309 determines a respective state metric for all fuel cell stacks at at at least two load points, in particular in a partial load range and a high load range, and these are stored in a memory in memory step 311 in order to be available as initialization values for a restart of the fuel cell system, as indicated by line 313.

If a decreasing power requirement then occurs in a request step 315, a check step 317 checks whether the power requirement falls below a predefined threshold, so that a fuel cell stack is intended to be shut down. If this is the case, a prediction step 319 predicts whether the remaining fuel cell stacks should be operated in a partial load range or a high load range.

Depending on the outcome of the prediction, the fuel cell stack is selected for deactivation in a deactivation step 321, whose state metric would result in maximizing a deviation from state metrics of other fuel cell stacks during operation in the predicted load range.

In a repeat step 323, the deactivation step 321 is repeated until the power requirement is met or all fuel cell stacks are deactivated.

1. A fuel cell system (100),
wherein the fuel cell system (100) comprises the following:
a plurality of fuel cell stacks (101, 103, 105) and
a control device (107),
wherein the control device (107) is configured to assign to each fuel cell stack (101, 103, 105) of the plurality of fuel cell stacks (101, 103, 105) a state metric quantifying an aging state of a respective fuel cell stack (101, 103, 105), and
respective fuel cell stacks (101, 103, 105) of the plurality of fuel cell stacks (101, 103, 105) depending on the state metric such that a difference between the state metrics of the respective fuel cell stacks (101, 103, 105) is minimized.

2. The fuel cell system (100) according to claim 1,
wherein
the control device (107) is configured to,
for a connection operation in which an inactive fuel cell stack (101, 103, 105) of the plurality of fuel cell stacks (101, 103, 105) is to be activated due to a power requirement, select that fuel cell stack (101, 103, 105) from the plurality of fuel cell stacks (101, 103, 105) which, of all the non-activated fuel cell stacks (101, 103, 105) of the plurality of fuel cell stacks (101, 103, 105), has the state metric which comes closest to a reference state metric.

3. The fuel cell system (100) according to claim 1,
wherein
the control device (107) is configured to determine a voltage applied to a respective fuel cell stack (101, 103, 105) at a predefined reference operating point and to assign a state metric to the determined voltage using a predefined assignment scheme.

4. The fuel cell system (100) according to claim 1,
wherein
the control device (107) is configured to determine a voltage hysteresis of a voltage applied to a respective fuel cell stack (101, 103, 105) at a predefined reference operating point change and assign a state metric to the voltage hysteresis using a predefined assignment scheme.

5. The fuel cell system (100) according to claim 1,
wherein
the control device (107) is configured to apply a predefined electrical current to a respective fuel cell stack (101, 103, 105) in order to determine an electrical resistance of the fuel cell stack (101, 103, 105) and assign a state metric to the electrical resistance of the fuel cell stack (101, 103, 105) using a predefined assignment scheme.

6. The fuel cell system (100) according to claim 1,
wherein
the control device (107) is configured to determine a resistance hysteresis of an electrical resistance of a respective fuel cell stack (101, 103, 105) at a predefined reference operating point change and assign a state metric to the resistance hysteresis using a predefined assignment scheme.

7. The fuel cell system (100) according to claim 1,
wherein
the control device (107) is configured to determine a state of a fuel cell stack (101, 103, 105) on at at least one catalyst layer, and at least one membrane, and/or a mass transport path of respective fuel cells of the fuel cell stack (101, 103, 105) and to assign a catalyst state metric to the catalyst layer, and assign a membrane state metric to the membrane, as well as assign the mass transport path metric to the mass path, and
the control device (107) is configured to,
when a load demand is present in a partial load range which is below a predefined threshold value, to select that fuel cell stack (101, 103, 105) for activation in response to the load requirement whose catalyst state metric comes closest to a reference catalyst state metric, or,
when a load demand is present in a partial load range which is above a predefined threshold value, to select that fuel cell stack (101, 103, 105) for activation in response to the load requirement whose membrane state metric comes closest to a reference membrane state metric of the fuel cell system, or,
when a load requirement is in a partial load range that is above the predefined threshold, select that fuel cell stack (101, 103, 105) for activation in response to the load requirement whose mass transport path state metric is closest to a reference mass transport path state metric.

8. The fuel cell system (100) according to claim 1,
wherein
the control device (107) is configured to predict the load requirement for a respective fuel cell stack (101, 103, 105) based on fuel cell system (100) operating parameters for a predefined period of time.

9. The fuel cell system (100) according to claim 1,
wherein
the control device (107) is configured to select, given a decreasing power requirement, the fuel cell stack (101, 103, 105) for deactivation whose state metric deviates the most from its reference state metric.

10. The fuel cell system (100) according to claim 1,
wherein
the control device (107) is configured to activate the respective fuel cell stacks (101, 103, 105) of the plurality of fuel cell stacks (101, 103, 105) in a closed control loop depending on the state metric.

11. A method (200, 300) for operating a fuel cell system (100) having a plurality of fuel cell stacks (101, 103, 105),
wherein the method (200, 300) comprises:
assigning a state metric to each fuel cell stack (101, 103, 105) of the plurality of fuel cell stacks (101, 103, 105), wherein the state metric quantifies an aging state of the fuel cell stack (101, 103, 105),
activating respective fuel cell stacks (101, 103, 105) of the plurality of fuel cell stacks (101, 103, 105) depending on the state metric such that a deviation between the state metrics of the respective fuel cell stacks (101, 103, 105) is minimized.

12. A vehicle having one fuel cell system according to claim 1.
